(19) United States
(12) Patent Application Publication
(10) Pub. No.: US 2005/0244016 A1
(43) Pub. Date: Nov. 3, 2005

(54) Parametric loudspeaker with electro-acoustical diaphragm transducer

(75) Inventors: Elwood G. Norris, Poway, CA (US); James J. Croft III, Poway, CA (US)

Correspondence Address: THORPE NORTH & WESTERN, LLP., 8180 SOUTH 700 EAST, SUITE 200, P.O. BOX 1219, SANDY, UT, 84070, US

(73) Assignee: American Technology Corporation

(21) Appl. No.: 11/121,151

(22) Filed: May 2, 2005

Related U.S. Application Data
(63) Continuation-in-part of application No. 09/981,331, filed on Oct. 16, 2001, now abandoned.
Application No. 09/981,331 is a continuation-in-part of application No. 09/787,972, filed on Jan. 17, 2002.
Application No. 09/787,972 is a continuation-in-part of application No. 09/159,442, filed on Sep. 24, 1998.
Application No. 09/159,442 is a continuation of application No. 09/105,380, filed on Jun. 26, 1998, now Pat. No. 6,188,772.
Application No. 09/105,380 is a continuation-in-part of application No. 09/006,134, filed on Jan. 13, 1998, now Pat. No. 6,151,398.
Application No. 09/006,134 is a continuation-in-part of application No. 09/006,689, filed on Jan. 13, 1998, now Pat. No. 6,108,433.
Application No. 09/006,689 is a continuation-in-part of application No. 09/006,133, filed on Jan. 13, 1998, now Pat. No. 6,044,160.
Application No. 09/006,133 is a continuation-in-part of application No. 09/004,090, filed on Jan. 7, 1998, now Pat. No. 6,304,662.
Application No. 09/004,090 is a continuation-in-part of application No. 08/819,614, filed on Mar. 17, 1997, now Pat. No. 6,011,855.

(51) Int. Cl. H04B 3/00; H04B 5/00

(52) U.S. Cl. 381/77; 381/79

(57) ABSTRACT

A method is disclosed for generating parametric audio output based on the interaction of multiple ultrasonic outputs within air as a nonlinear medium. The method includes the step of generating an electronic signal comprising at least two ultrasonic signals having a difference in value which falls within an audio frequency range. The electronic signal can be transferred to an electrostatic emitter diaphragm which couples directly with the air as part of a single stage energy conversion process. The electronic signal can be converted at the diaphragm directly to a mechanical displacement as a driver member of a parametric speaker. The ultrasonic signals can be mechanically emitted from the diaphragm into the air as ultrasonic compression waves which interact within the air to generate the parametric audio output.

### CROSS-REFERENCE TO RELATED APPLICATIONS AND CLAIM OF PRIORITY

This application is a continuation in part of U.S. application Ser. No. 09/981,331, filed Oct. 16, 2001, which is a continuation in part of U.S. application Ser. No. 09/787,972 which is the National Stage of International Application No. PCT/US99/19580, filed Aug. 26, 1999, which is a continuation in part of U.S. application Ser. No. 09/159,442, filed Sep. 24, 1998, which is a continuation of U.S. Pat. No. 6,188,772, filed Jun. 26, 1998, which is a continuation in part of U.S. Pat. No. 6,151,398, filed Jan. 13, 1998, which is a continuation in part of U.S. Pat. No. 6,108,433, filed Jan. 13, 1998, which is a continuation in part of U.S. Pat. No. 6,044,160, filed Jan. 13, 1998, which is a continuation in part of U.S. Pat. No. 6,304,662, filed Jan. 7, 1998, which is a continuation in part of U.S. Pat. No. 6,011,855, filed Mar. 17, 1997, all of which are herein incorporated by reference.

### FIELD OF THE INVENTION

This invention relates to electrostatic loudspeaker transducers. More particularly, this invention relates to parametric loudspeaker transducers that include a stator element and are based on film type diaphragms. These transducers involve a single stage, electromechanical conversion of ultrasonic voltage signals to ultrasonic compression waves whose difference in value corresponds to new sonic or subsonic compression wave frequencies.

### BACKGROUND

A parametric loudspeaker is a sound emission device that directly emits high frequency ultrasonic waves represented by a carrier frequency and sideband frequencies resulting from modulation of the carrier frequency with an audio signal. These diverse ultrasonic frequencies are demodulated within a nonlinear medium such as air to regenerate the modulated audio signal into actual audio output. In theory, parametric sound is developed by the interaction in air (as a nonlinear medium) of two ultrasonic frequencies whose difference in value falls within the audio range. Ideally, the resulting audio compression waves would be projected within the air and would be heard as pure sound. Despite the ideal theory, sound production by acoustic heterodyning for practical applications has eluded the industry for over 100 years.

Because the production of audio output extends along the length of the ultrasonic propagation, increasing sound pressure levels (SPL) develop along the ultrasonic beam until the ultrasonic energy is dissipated. In this manner, the output of the parametric speaker is similar to an end fired array of conventional speakers. Despite some similarities between parametric speakers and conventional speaker systems, significant new properties arise because the audio output is indirectly generated from high energy ultrasonic emissions, rather than by cones or diaphragms moving at audio frequencies. Some of these unique properties are well known, such as a long range beaming effect and localization of sound to a projected area. Other properties have not previously been recognized, and have prevented the realization of commercial parametric speaker systems. This disclosure, along with a concurrently filed application Ser. No. 09/384,084, filed on Aug. 26, 1999 and entitled “Modulator Processing for Parametric Speaker Systems”, explores several of these properties as part of a fully operational parametric speaker. The current invention's parametric speaker has full range audio output with volume, clarity and fidelity which are competitive with high quality conventional sound systems.

Prior art efforts in parametric speaker applications have generally been limited to the theoretical investigation into certain limited properties and applications of a transducer array of piezo bimorph transducers which are collectively mounted on a support surface. Each bimorph emitter was separately wired to the signal source. Based on this configuration, commercial development of parametric products has eluded the industry. This is primarily due to a lack of effective sound reproduction competitive with other conventional sound systems such as dynamic and electrostatic speaker systems. Even where parametric speakers offered a distinct advantage, such as enhanced directionality, commercial success has been nominal because of high cost, substantial power requirements, and poor quality which have not satisfied discerning listeners.

Parametric speakers rely on the effective coupling of an ultrasonic sound output of a unique nature with surrounding air. As mentioned above, previous theoretical and commercial product research has focused primarily on emitter devices that use piezoelectric bimorph structures, also known as piezoelectric benders. These devices use two layers of piezoelectric material that are bonded to each other and are driven out of phase. As one layer expands in length, the other contracts, providing output movement in a plane 90 degrees to the expansion/contraction direction. While the force of these devices is quite high, the actual air displacement and coupling is rather poor. Therefore, successful performance of the bimorph relies on a second stage of conversion process in which the localized movements of the bimorph are amplified within the surrounding air. This is accomplished with various air matching means that consist of plate and disc structures that are comparable in size to a wavelength of the frequency of interest.

In order to develop meaningful SPL, many of these devices are spaced along a support plate or other support structure. See, for example, FIG. 6 taken from Tanaka et al, U.S. Pat. No. 4,823,908, including clusters of 500 to over 1400 bimorph units. Because each of these devices represents a localized emitter, the present inventors have discovered that high drive intensity immediately in front of each device can readily drive the air into shock or saturation. This phenomenon breaks down the effective demodulation of the audio signal, causing loss of power output and severe distortion of the audio sound component, as well as other serious adverse effects upon the general process of parametric loudspeaker operation. In addition, bimorphs have poor frequency response and unwanted sub-harmonics.

To a large extent, prior art efforts for enhancement of SPL in bimorph systems have focused on increasing the number of bimorph emitters. While it has been perceived that increasing the number of bimorph emitters would provide increased ultrasonic output, it merely exaggerates the problem of air saturation and serious power loss. Furthermore, the inventors have discovered a number of accompanying limitations with phase matching errors due to variations from device to device, distortion and bandwidth problems and the associated cost and complexity of using so many separate devices. Indeed, the phase relationships of these separate devices are such that the total output of many devices used as a cluster does not add up to the amount predicted by just summing all the devices. For example, it has been experimentally shown that an array of 10 bimorph transducers, each individually capable of generating an SPL of 120 db, produces a collective SPL of only 125 to 127 db. Notably, this is surprisingly less than the 130 db which theoretically represents the accumulation of ten devices having individual outputs of 120 db. As indicated above, the present inventors believe that this power loss arises from the phase anomalies, and other deficiencies identified in this disclosure.

Another factor which has perhaps channeled investigators to rely on bimorph devices is a perception that the emitter should be structured with dimensions corresponding to wavelengths of the ultrasonic energy to be emitted. This is in accordance with other types of ultrasonic devices, such as electrostatic emitters, which are constructed at a size equal to or greater than the wavelength of the lowest frequency of interest. Even when using these devices, it is still required to use large device counts to achieve the required output. In fact, the perception has been that if higher SPL is desired, greater numbers of emitters must be applied, driven with higher voltage levels. Such logic arises from traditional design perceptions from conventional audio systems. However, these conclusions do not follow in parallel relationship with parametric speaker systems.

The present inventors believe that, in addition to unsatisfactory results in parametric systems with bimorph transducers, other traditional perspectives derived from conventional audio systems may have misguided early researchers in the field of parametric speakers, leading to disappointing results which have deterred parametric speaker progress. This is represented by the fact that early research efforts were substantially limited to the use of bimorph transducers, which are generally classified as high power devices. It seems that the preferential use of bimorph transducers within parametric speakers may have been a natural consequence of a parallel experience within the audio industry, where dynamic speakers (also characterized as high power devices) were strongly favored over electrostatic speakers. In other words, the popularity and general acceptance of magnetically driven cones (similar in nature to bimorph drivers and attached air coupling cones) appear to have channeled developmental thinking within the parametric field in favor of bimorphs and away from low output emitter structures such as film emitters.

For example, approximately 99 percent of audio systems sold in the world fall within the class of dynamic speakers, represented by a magnetic driving unit which is mechanically coupled to a cone or similar acoustic drivers. Dynamic speakers operate based on two concepts. The first involves an electro-mechanical process of converting the voltage signal of the audio output to a mechanical movement. This is accomplished by the magnetic driving unit such as a magnet and coil combination. The second concept accompanies the first, wherein the mechanical movement is combined with an acoustical coupling device, such as with movement of the cone for displacement of compression waves. This is conceptually referred to as a two stage speaker.

Such dynamic speakers are referred to as high power devices because they are able to generate high levels of volume, particularly at low frequencies, based on the strength of the drive system. They are also well suited for adaptation within small spaces such as small rooms, automobiles, etc. The versatility of dynamic speakers and their simplicity of operation (a moving cone) have favored a substantially uninterrupted lead position over electrostatic speakers and other systems for audio reproduction. Furthermore, such development has occurred despite the need for expensive and complex audio control systems for mixing, cross-over, equalization, and related problems such as were enumerated in U.S. parent application Ser. No. 08/684,311, incorporated herein by reference.

Despite the market strength of dynamic speakers, the electrostatic speaker industry has offered significant potential for commercial benefit. However, because of low power output, large size requirements and construction limitations, electrostatic speakers have failed to capture a significant market share—less than 1%. In spite of the clear advantages offered by electrostatic speakers over dynamic speakers within the audio industry, commercial development and research continues to focus on the higher power, magnetically driven dynamic systems.

It now appears likely that this trend within the acoustic world has affected the direction of research within the parametric field of sound reproduction as well. Specifically, virtually all parametric investigation prior to the present inventors has been with the use of bimorph transducers, similar in construction to the dynamic speaker with its high power operation. As noted above, bimorph systems have not realized the necessary results for commercialization of parametric speaker systems. Having failed to realize required levels of volume and quality with the “high power” form (bimorph transducer) of an ultrasonic emitter, there has been an apparent assumption by those skilled in the art that electrostatic or low power film-type emitters would be even less likely to perform in the parametric sound field. So, the use of broad film diaphragms and similar single-stage electro-acoustical conversion systems have not been considered as a transducer suitable for parametric investigation.

The science of acoustics has long known of the utility of a movable electrostatic membrane or film associated with and insulated from a stator or driver member as a speaker and/or microphone device. Typical construction of such devices includes a flexible Mylar™ or Kapton™ film having a metalized coating and an associated conductive, rigid plate which are separated by an air gap or insulative material. An applied voltage including a sonic or ultrasonic signal is transmitted to this capacitive assembly and operates to displace the flexible emitter film to propagate the desired ultrasonic or sonic compression wave.

Two primary categories of electrostatic speakers exist. Single-ended speakers comprise a single plate, typically having holes to allow the sound to pass through. The film is suspended in front of or behind the plate, and may be displaced from contact with the plate by spacers. With ultrasonic emitters, the film has been biased in direct contact with an irregular face of the plate, and the film is allowed to vibrate in pockets or cavities. An insulation barrier of either air, plastic film or similar nonconductive material is sandwiched between the film and plate to prevent electrical contact and arcing. Typically, the plate and diaphragm are coupled to a DC power supply to establish opposing polarity at the respective conducting surfaces of the metalized coating and the plate.

The second primary category of electrostatic speakers is represented by the push-pull configuration. In this case, the speaker has two rigid plates which are symmetrically displaced on each side of a conductive membrane. When voltage is applied, one plate becomes negative with respect to the membrane while the opposing plate assumes a positive charge. The transmission of a variable voltage (e.g. AC) to the transducer reinforces the effect of push and pull on the membrane, thereby enhancing power output. Further details of theory and construction of common electrostatic emitter designs is found in Electrostatic Loudspeaker by Ronald Wagner, Audio Amateur Press, 1993.

Many years of directed research have developed a variety of technical improvements to this basic system, but the component definition has remained substantially the same. Surprisingly, the present inventors have discovered that a single-stage conversion process using such low power transducers as piezoelectric films, electrostatic films, and other similar film emitters offer significant advantages for parametric speakers. The following disclosure provides further enhancements to these concepts and embodiments previously recited in the referenced parent applications.

### SUMMARY OF THE INVENTION

A method is disclosed for generating parametric audio output based on the interaction of multiple ultrasonic outputs within air as a nonlinear medium. The method includes the step of generating an electronic signal comprising at least two ultrasonic signals having a difference in value which falls within an audio frequency range. The electronic signal can be transferred to an electrostatic emitter diaphragm which couples directly with the air as part of a single stage energy conversion process. The electronic signal can be converted at the diaphragm directly to a mechanical displacement as a driver member of a parametric speaker. The ultrasonic signals can be mechanically emitted from the diaphragm into the air as ultrasonic compression waves which interact within the air to generate the parametric audio output.

### BRIEF DESCRIPTION OF THE DRAWINGS

FIG. 1a is a drawing representing prior art parametric loudspeakers using multiple piezo bimorph transducers.

FIG. 1b is drawing representing another embodiment of parametric loudspeakers using multiple piezo bimorph transducers.

FIG. 1c is a drawing of bimorph transducers driving the air at small points in space and causing shock.

FIG. 1d is a drawing of a film transducer of the invention driving the air in a homogenous fashion that distributes the drive and reduces shock.

FIG. 1e is a drawing of a primary frequency waveform below shock level and at shock level.

FIG. 2 is an orthogonal top view of a circular V grooved back plate for a large scale electrostatic film transducer.

FIG. 2a is a sectional view of the electrostatic back plate and diaphragm film of FIG. 2, taken along the lines of 2a-2a.

FIG. 2b is a drawing of an electrostatic transducer with a curved back plate and diaphragm.

FIG. 3 is a drawing of a rectified sine form of piezo film.

FIG. 3a is a drawing of a rectified sine form of piezo film with a quarter wave spaced back plate.

FIG. 3b is a drawing of a shallow rectified sine form of piezo film.

FIG. 3c is a drawing of a shallow rectified sine form of piezo film with back plate.

FIG. 4 is a drawing of a sinusoidal shaped piezo film.

FIG. 4a is a drawing of a sinusoidal shaped piezo film with a backplate.

FIG. 4b is a drawing of a sinusoidal shaped piezo film with a backplate and a curvature to open up the directivity angle of the primary frequencies.

FIG. 4c is a drawing of a sinusoidal shaped piezo film used in dipolar primary frequency/bipolar secondary frequency mode.

FIG. 5 is a drawing of a back plate to be used with piezo film in either a concave or convex dimpled form.

FIG. 5a is a drawing of piezo film used in a convex dimpled form.

FIG. 5b is a drawing of piezo film used in a concave dimpled form.

FIG. 6 is a drawing representing prior art parametric loudspeakers using multiple piezo bimorph transducers as an ultrasonic emitting source.

FIG. 7 is a drawing representing another prior art embodiment of parametric loudspeakers using multiple piezo bimorph transducers and representing various deficiencies in speaker performance.

FIG. 8 is an perspective view of an emitter drum transducer made in accordance with the principles of the present invention.

FIG. 9 is a top view showing a plurality of apertures in an emitter face of the emitter drum transducer.

FIG. 10 is a cut-away profile view of the emitter drum transducer and the emitter face, showing the membrane which is disposed over the apertures in the emitter face.

FIGS. 11A-B are close-up profile views of membranes which are vibrating while stretched over a plurality of the apertures in the emitter face.

FIG. 12 is a graph showing an example of membrane (piezoelectric film) displacement versus frequency in the preferred embodiment. The graph shows resonant frequency and typical bandwidth generated.

FIG. 13 is a cut-away profile view of the emitter drum transducer of an alternative embodiment where the emitter drum transducer is pressurized.

FIG. 14 is a more specific implementation of the present invention which transmits an ultrasonic base frequency and an ultrasonic intelligence carrying frequency which acoustically heterodyne to generate a new sonic or subsonic frequency.

FIG. 15 is a perspective view of a transducer with a diaphragm which has preformed concave oval shapes.

FIG. 16 is a cross-section of FIG. 15 showing the transducer with preformed membranes which vibrate to produce an ultrasonic wave.

FIG. 17 depicts a cross-sectional side view of a single-end of an electrostatic speaker.

FIG. 18 shows a single-end speaker device with a foam member as a stator.

FIG. 19 shows an arcuate shape representing a curved configuration for the present speaker device.

FIG. 20 shows a cylindrical shape representing a possible configuration for the speaker device

FIG. 21 is a schematic of a basic form of a foam stator speaker embodiment of the speaker device in push-pull configuration.

FIG. 22 illustrates an embodiment of the speaker device where the film is sandwiched between opposing foam stators.

FIGS. 23 and 24 show multiple film embodiments of the speaker device.

FIG. 25 is a top perspective view showing a thin film diaphragm having a plurality of conductive coils disposed on the emitter diaphragm and suspended over a magnetic core element.

FIG. 26 is an exploded view of an alternate embodiment showing opposing conductive coils on the emitter diaphragm and core.

FIG. 27 is a cut-away, top perspective view showing a thin film diaphragm having a plurality of conductive rings disposed on the emitter diaphragm and suspended over a core element.

FIG. 28 is an elevated, perspective view of a resonance tuned electrostatic emitter.

FIG. 29 is a cross section of the emitter of FIG. 28.

FIG. 30 is a cross-sectional side view of a hemispherical electrostatic speaker.

FIG. 31 is a perspective, partial cutaway view of a hemispherical electrostatic speaker.

FIG. 32 is a perspective side view of a spherical electrostatic speaker.

### DISCLOSURE OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the present invention, and should not be viewed as narrowing the claims which follow.

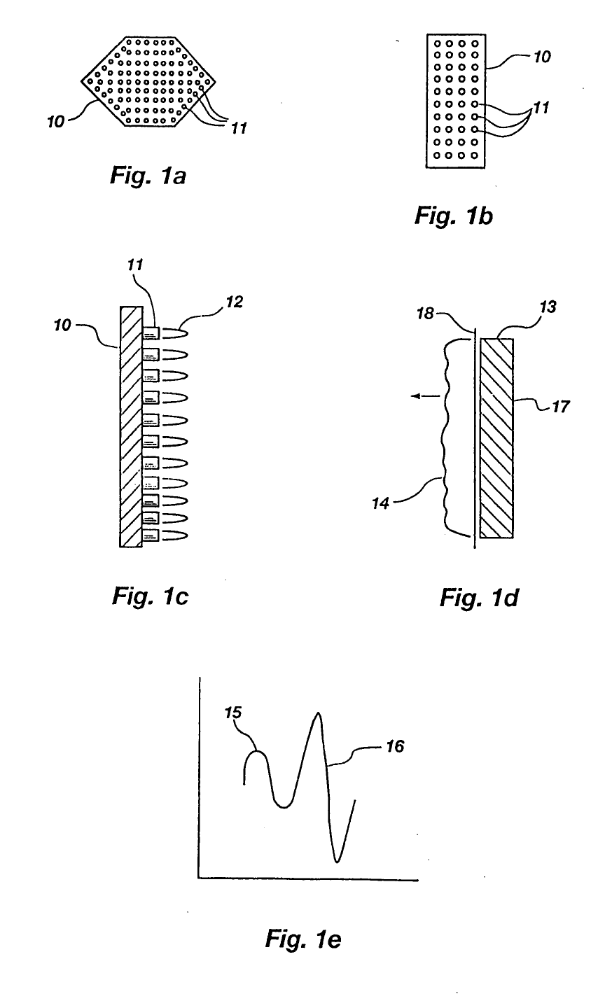

FIGS. 1a and 1b are drawings representing prior art parametric loudspeakers 10 using multiple piezo bimorph transducers 11. These have been used with clusters of 500 to over 1500 bimorph transducers. One of the difficulties with parametric loudspeakers is that when driving the air at ultrasonic levels to provide reasonable conversion efficiency and loudness at the secondary resultant frequencies, the air can be driven into a shock limit where the fundamental frequency cannot get any louder and only the distortion component levels increase. This shock limit is worse when driving individual, small points of air space. The more confined the intensity, the easier shock comes into existence.

FIG. 1c is a drawing of a group of bimorph transducers each driving the air at small points in space 12 and causing shock. FIG. 1d is a drawing of a film transducer 13 of the invention driving the air in a homogenous fashion that distributes the drive 14 and reduces shock. A piece of piezoelectric film 18 is spaced from the electrically charged base 17 so that when a signal is applied to the base 17 a mechanical interaction is produced. FIG. 1e is a drawing of a primary frequency waveform below shock level 15 and at shock level 16.

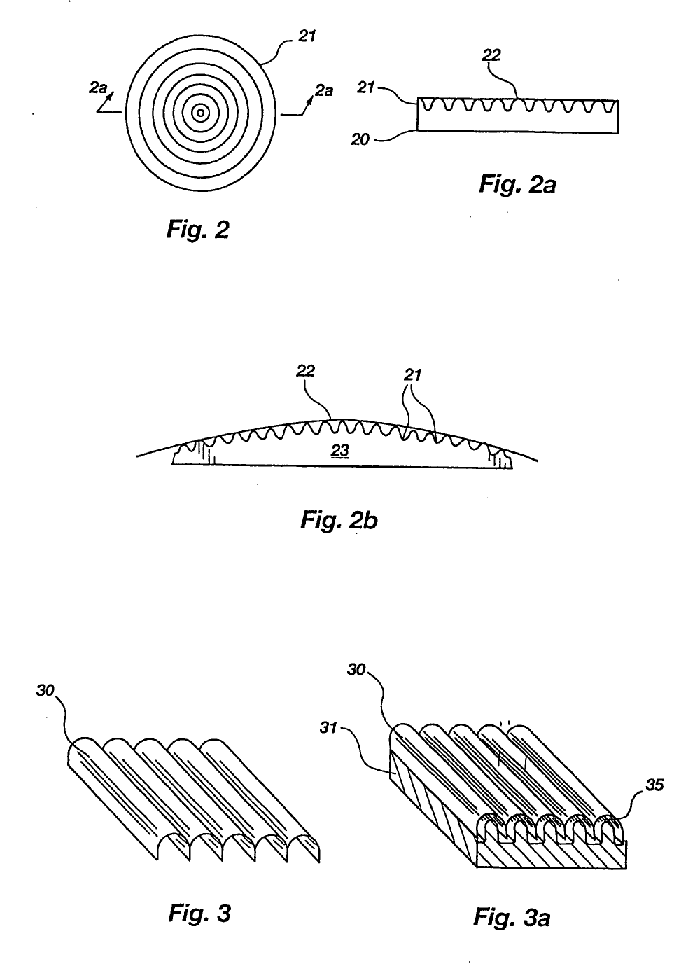

One preferred embodiment of a large scale film transducer is based on electrostatic drive principles. The electrostatic type transducer uses a conductive backplate with a conductive film in close proximity to the backplate. A bias is applied to either the film or the backplate and both the film and the backplate are driven by two polarities of the drive signal. FIG. 2 is a top view and FIG. 2a is a cross-sectional view of a large scale electrostatic film transducer with a circular V-grooved back plate 21. The back plate design may alternatively be pitted (concave) or dimpled (convex) in shape.

When high frequencies are projected from relatively large diaphragms, as compared to the wavelength of the frequency of interest, the beam of sound can achieve such high directivity that the high frequencies will focus down to a tight beam. This can cause overly concentrated directivity and premature shock formation of the sound waves due to high intensities being focused in a small airspace. By curving the diaphragm, the radiation pattern can be opened up to have a directivity window comparable in width to the size of the transducer or even a somewhat wider spreading of sound to minimize shock limited waveforms. FIG. 2b shows an electrostatic film transducer with a curved backplate 23 and complementary shaped film diaphragm 22 that solves this problem.

Another embodiment of the invention utilizes piezoelectric film made of polyvinylidiene di-fluoride (PVDF). This film expands and contracts when electrically excited and must therefore be deformed to achieve acoustic output. It should be realized that these large area film transducers include but are not limited to electrostatic film, electret film, piezo film such as PVDF, electrothermal mechanical film, and planar magnetic configurations.

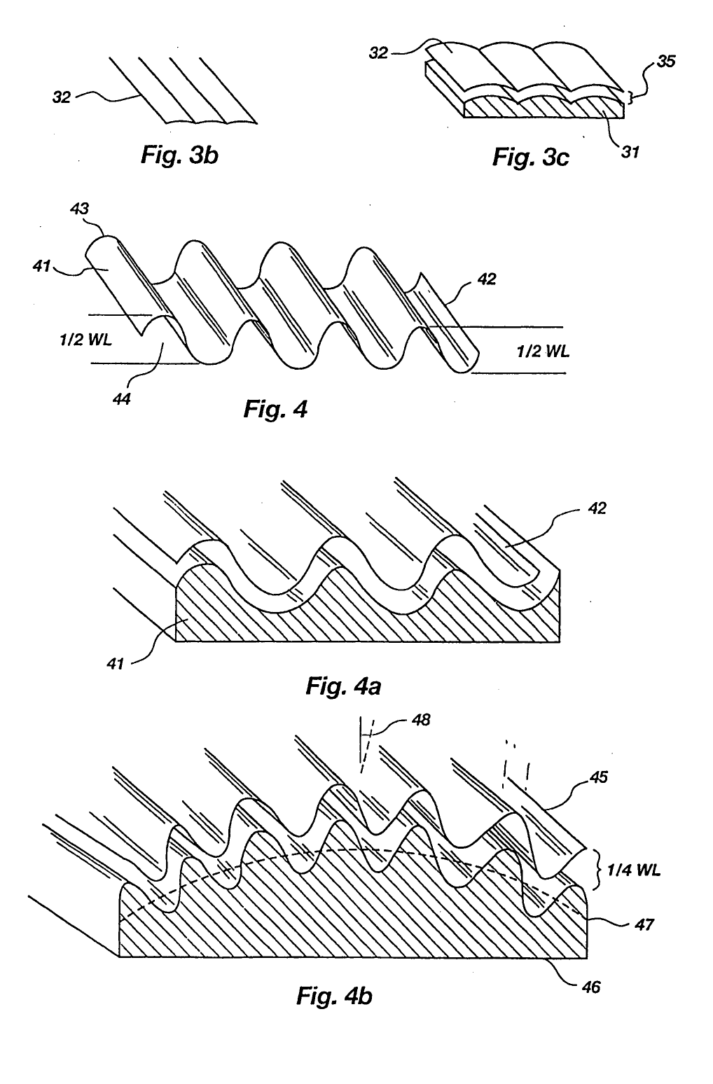

A preferred shape of the piezo film 30 as a rectified sine shape is shown in FIG. 3. FIG. 3a is a drawing of a rectified sine form of piezo film 30 with a quarter wave spaced back plate 31. By spacing the backplate 31 at a quarter of a wave length 35 from the film, the output of the emitter can increase up to 3 dB at the frequency whose wavelength is four times the distance from film to back plate. FIG. 3b is a drawing of a shallow rectified sine form of piezo film 32. FIG. 3c is a drawing of a shallow rectified sine form of piezo film 32 with back plate 31 spaced a quarter wavelength from the piezo film 32.

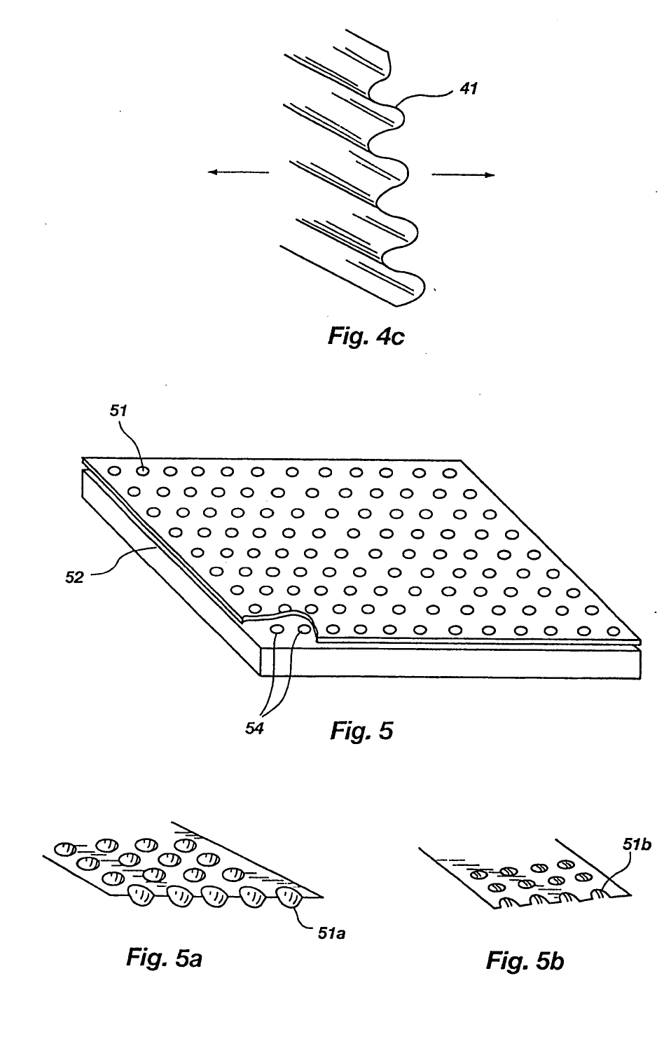

FIG. 4 is a drawing of a sinusoidal shaped piezo film emitter 42. This form can be efficient enabling movement of all of the film as an emitter structure. For sine shapes that are much greater than or much less than ½ of a wave length (wL) in peak to peak height, the peaks 43 and troughs 44 can be out of phase with each other. In this case, a compensating procedure, such as electrically driving the peaks in opposite phase from the troughs may be required. FIG. 4a is a drawing of a sinusoidal shaped piezo film emitter 42 with spaced backplate 41. FIG. 4b is a drawing of a sinusoidal shaped piezo film 45 with a backplate 46 and a curvature 47 to open up the directed angle 48 of the primary frequencies. This arrangement minimizes shock formation and opens up the window of dispersion as in the above mentioned electrostatic example.

Most ultrasonic emitters and parametric loudspeakers are essentially monopole in radiation pattern. As shown in FIG. 4c, a bipolar parametric loudspeaker can be realized with the invention by using an open film (e.g. PVDF) without a backplate, which radiates in a bipolar out-of-phase radiation pattern in the primary frequency range while simultaneously operating in a bipolar in-phase manner for all secondary parametrically derived signals. This could be used where one wanted to project highly directive, in phase sounds in two opposite directions. This is not practical to do with any prior art devices. FIG. 4c is a drawing of a sinusoidal shaped piezo film 41 used in bipolar primary frequency/bipolar secondary frequency mode.

Another diaphragm form for piezo film is either a concave or convex dimpled structure. This shape may be achieved by thermo-forming the film or utilizing foam support structure to push the film into this shape. Forming the film into curved emitter sections can also be achieved by pushing or pulling the film into cavities with positive or negative pressure. In addition, it is possible to utilize foam or plastic support structure to push the film into desired shapes.

FIG. 5 is a drawing of piezo film 51 with a back plate 52 generating either concave or convex forms. The chambers 54 in the backplate 52 are pressurized with either positive or negative pressure to produce the concave or convex dimples. These chambers 54 can be pressurized separately or they may be part of a larger interconnected pressure chamber. FIG. 5a is a drawing of piezo film 51a used in a dimpled form with a concave shape. FIG. 5b is a drawing of piezo film 51b used in a dimpled form of convex character. It will be apparent to those skilled in the art that many variations for developing the desired curvature in piezo film can be applied under the concepts of this invention. Furthermore, numerous support mechanisms may be developed to provide these desired curvatures within the piezo film, particularly as applied to the development of parametric output of audio sound as a secondary emission from the primary ultrasonic emissions.

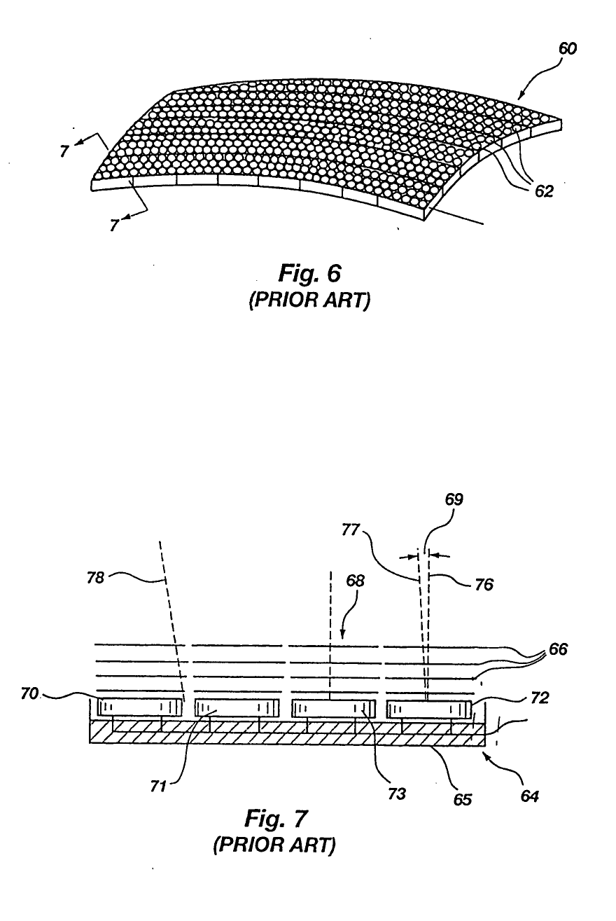

The adaptability of a flexible film diaphragm offers many advantages over the conventional rigid bimorph devices. Some of these benefits are more specifically illustrated in FIGS. 6 and 7. FIG. 6 is a drawing representing a prior art parametric loudspeaker 60 using multiple piezo bimorph transducers 62. As mentioned, these have been used in clusters of between 500 to 1500 bimorph transducers in an effort to generate effective parametric output. This disclosure has already identified one deficiency in the use of bimorph emitters which arises from the saturation of air at local emission regions immediately in front of the transducer face. FIG. 7 graphically illustrates this cause of distortion, as well as other deficiencies that arise from the prior art parametric array 64 by reason of phase distortion and misalignment. These incongruities, such as the referenced phase anomalies, are represented in the bimorphs 70, 71, 72 and 73 of FIG. 7.

It is important to note that these bimorph emitters are separate structures which typically have different physical and electrical properties. Indeed, such bimorph transducers may be manufactured from different batches of material, with different construction environments. Typically, they are thrown into a common bin and distributed on a random selection basis as customers designate particular design specifications. As a consequence, mismatch of phase in propagated ultrasonic waves 66 can result in phase cancellation and other forms of sound and directional distortion represented by phantom lines 77 and 78. Item 78 shows the bending effect of adjacent ultrasonic beams where the respective frequencies from each emitter are out of phase. For example, emitter 70 is propagating waves which are slightly out of phase with the waves from emitter 71. Phantom line 78 illustrates a directional shift of the audio output from the parametric speaker which arises from the phase misalignment. Emitter 72 has been mounted askew, as illustrated by the acute angle 69 which is slightly divergent from a perpendicular axis 76 with respect to a mounting support plate 65. Here again, the beams propagated from the emitters are not collimated and properly phase aligned results in a loss of energy and possible distortion. As these factors are multiplied by 500 to 1500 emitters which are typically combined to make a conventional parametric array, the adverse effects can be significant. In addition, it appears that these devices tend to have many harmonic resonances and anti-resonances which are further distorted in the demodulated audio component of the parametric loudspeaker.

In addition to the phase anomalies identified above, FIG. 7 represents the air saturation problem previously introduced. Indeed, one of the difficulties noted by the present inventors with parametric loudspeakers is that when driving the air at ultrasonic levels that provide reasonable conversion efficiency and loudness, the air can be driven into a shock limit where the fundamental frequency cannot get any louder and only the distortion components increase in level. This shock limit increases when driving small, individual points of air space, as occurs with bimorph transducers 73. The more confined the intensity, the easier shock comes into existence. This is particularly true of high intensity devices such as conventional bimorphs.

The present inventors have discovered that by distributing high levels of energy over broad surface areas of film, as opposed to the localized emitter elements of bimorph array transducers, the shock limit is controlled. Where an array of small bimorph emitters would be expected to generate a desired sound pressure level (SPL) when supplying 130 db to the emitters, the desired SPL falls short, and the distortion is greatly magnified.

Under the principles of the present invention, a broad emitter film is supplied with less than 120 db. However, by dispersing the energy over many small emitter sections of the film, the air is not driven into saturation or shock at any local point in front of the transducer. The conversion efficiency for parametric output produced by film emitters is very high, and distortion is substantially reduced. This process represents a diversion from prior art techniques of attempting to increase the volume by focusing higher db output from high intensity emitters, (such as the bimorphs).

In general, these various concepts represent a method for enhancing parametric audio output based on the interaction of multiple ultrasonic frequencies within air as a nonlinear medium. The following basic steps are implemented through one or more of the preceding types of structures. These steps are listed below, and involve:
a) generating an electronic signal comprising at least two ultrasonic signals having a difference in value which falls within an audio frequency range;
b) transferring the electronic signal to an electrostatic emitter diaphragm which couples directly with the air as part of a single stage energy conversion process;
c) converting the electronic signal at the diaphragm directly to mechanical displacement as a driver member of a parametric speaker; and
d) mechanically emitting the at least two ultrasonic signals from the diaphragm into the air as ultrasonic compression waves which interact within the air to generate the parametric audio output.

Another alternative step is selecting a transducer diaphragm having a dimension greater than the wavelength of the ultrasonic frequencies at their lowest frequency wavelength value. An extension of this concept is selecting a transducer diaphragm which has a dimension greater than ten times the wavelength of the ultrasonic frequencies at their lowest value.

Where the prior art techniques sought to increase SPL output by increasing db levels at the individual bimorph emitter surfaces, the present invention spreads out the energy over a larger surface area. Although this decreases the db level of compression waves propagated at any point in space, the overall effect is to increase the SPL because of the large surface area. Furthermore, because distortion is minimized, SPL can be raised to more effective levels. This represents a conceptual step of limiting the electronic signal to a maximum strength level which minimizes saturation of surrounding air at the respective arcuate emitter sections. The following geometries and correlated db levels illustrate appropriate balances of broad geometry with db emission levels of the film emitter.

An additional step which is readily implemented under the concepts of the present invention involves providing for improved collimating of the respective beams of ultrasonic energy propagated from each of the film emitter sections. The orientation of the beams can be controlled by the support structure of the backplate. Specifically, the single, common plate structure provides physical positioning of the array of emitter sections with greater accuracy. Prior positioning of bimorph devices required individual positioning of each emitter, leading to misalignment. With all the emitter sections properly aligned, ultrasonic emissions are collimated. Interference losses from out-of-phase interaction resulting from uncollimated emissions is significantly reduced. Tighter beaming of ultrasonic energy also provides more efficient conversion, in view of the virtual end-fired-array of demodulation of the audio signal from the ultrasonic emissions. Specifically, the tighter beam pattern provides more concentration to the demodulation of energy, thereby increasing the audio SPL along the length of the ultrasonic beam.

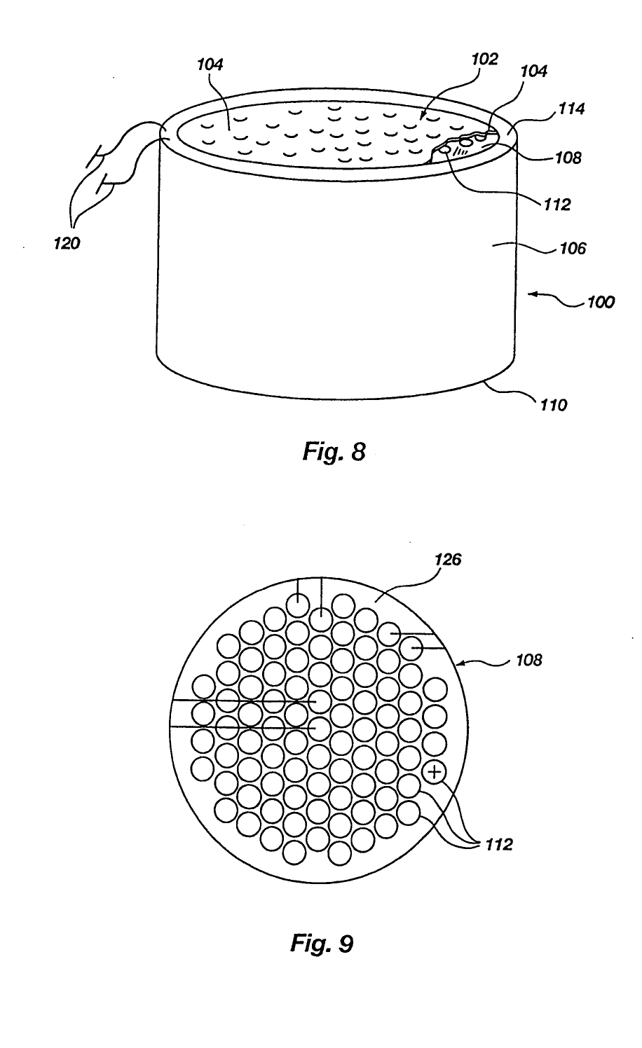

Another embodiment of this invention is FIG. 8 which shows a more efficient embodiment of an ultrasonic emitter. In the preferred embodiment shown in this perspective view, the emitter drum transducer 100 is a generally cylindrical object. The sidewall 106 of the emitter drum transducer 100 is preferably a metal or metal alloy. The outer surface of the emitter face 102 is comprised of a piezoelectric film 104. The piezoelectric film 104 is stimulated by electrical signals applied thereto, and caused to vibrate at desired frequencies to generate compression waves. Above the piezoelectric film 104 and disposed about the perimeter of the emitter face 102 is a conductive ring 114. The conductive ring 114 is used to apply voltages to the piezoelectric film 104. Underneath the piezoelectric film 104 is a preferably metallic cookie 108 (but which will be referred to hereinafter as a disk, see FIG. 9) to be described later.

The emitter drum transducer 100 is generally hollow inside, and is closed at a bottom surface by a back cover 110. The emitter drum transducer 100 is sealed so as to be generally airtight so that either a near-vacuum (hereinafter referred to as a vacuum) or a pressurized condition can exist within the emitter drum transducer 100. A positive pressure in the drum transducer 100 with a diaphragm one quarter of a wave length of a selected frequency from the rear plate can produce a useful back wave. One especially valuable selected frequency is the carrier frequency. Of course, a rear plate can also be used to absorb the back wave with fiberglass, foam or other sound wave absorbing materials.

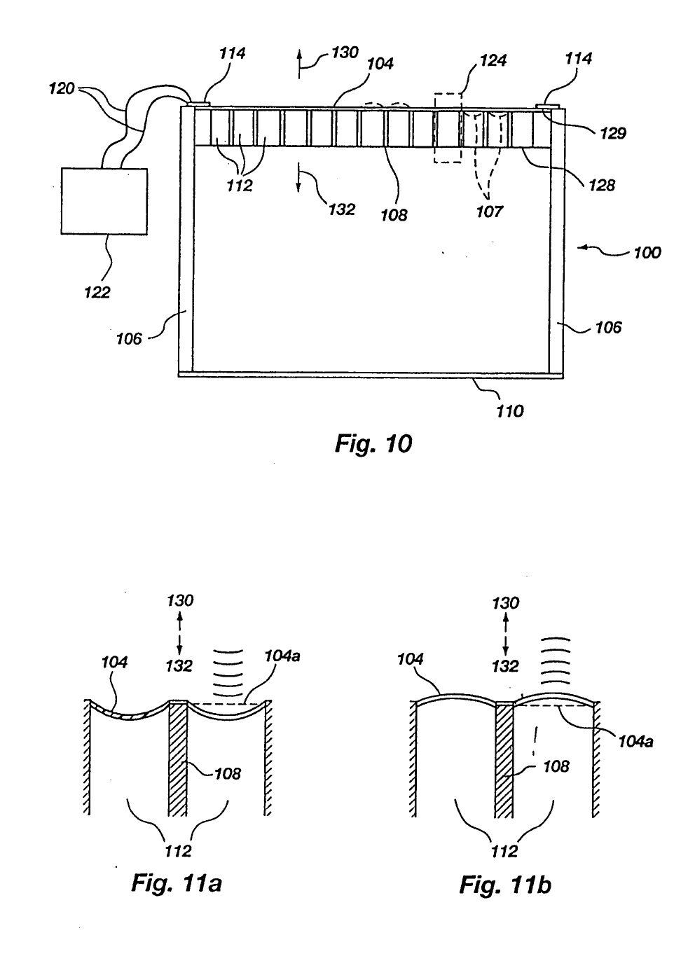

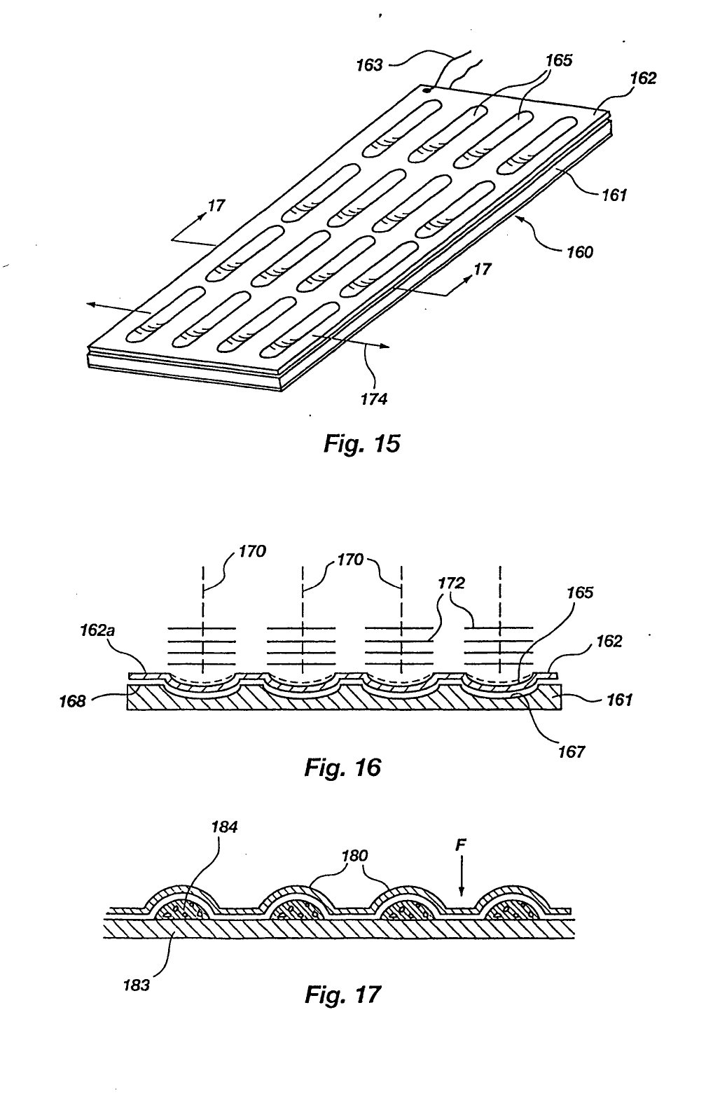

To better understand the structure of the emitter drum transducer 100, FIG. 9 provides a top view of an outward facing side 126 of the disk 108 disposed underneath the piezoelectric film 104 (see FIG. 8). In the preferred embodiment, the disk 108 is metallic and perforated by a plurality of apertures 112 of generally uniform dimensions. The apertures 112 extend completely through the thickness of the disk 108 from an inward facing side 128 (see FIG. 10) to the outward facing side 126. To provide predictability and the greatest efficiency in performance, the apertures 112 are formed in the shape of cylinders if bidirectional piezo film is used. Where unidirectional film is applied, an elongate shape as illustrated in FIG. 15 is preferable.

The aperture pattern 112 shown on the disk 108 in FIG. 9 is chosen in this case because it enables the greatest number of apertures 112 to be located within a given area. This pattern is typically described as a “honeycomb” pattern. The honeycomb pattern is selected because it is desirable to have a large number of apertures 112 having parallel axes because of the characteristics of acoustical heterodyning. Specifically in the case of generating ultrasonic frequencies, it is desirable to cause heterodyning interference between a base frequency and a frequency which carries intelligence to thereby generate a new sonic or subsonic frequency containing the intelligence. Consequently, the greater the number of base and intelligence carrying signals which are caused to interfere in close proximity to each other, the greater the volume of the new sonic or subsonic frequency produced. In other words, the present invention provides the significant advantage of generating a volume which is loud enough to be commercially viable. Parallel axes of frequency emission provides greater predictability for determining where the new sonic or subsonic frequency will be generated.

FIG. 10 provides a helpful profile and cut-away perspective of the preferred embodiment of the present invention, including more detail regarding electrical connections to the emitter drum transducer 100. The sidewall 106 of the emitter drum transducer 100 provides an enclosure for the disk 108, with its plurality of apertures 112 extending through the disk 108. The piezoelectric film 104 is shown as being in contact with the disk 108. Experimentation was used to determine that it is preferable not to glue the piezoelectric film 104 to the entire exposed surface of the disk 108 with which the piezoelectric film 104 is in contact. The varying size of glue fillets between the piezoelectric film 104 and the apertures 112 causes the otherwise uniform apertures 112 to generate resonant frequencies which are not uniform. Therefore, the preferred embodiment teaches only gluing an outer edge of the piezoelectric film 104 to the disk 108.

The back cover 110 is provided so that in the preferred embodiment, a vacuum or near-vacuum can be created within the emitter drum transducer 100. The near-vacuum will be defined as a pressure which is small enough to require measurement in millitorrs. There are several reasons for having a vacuum inside the emitter drum transducer 100. First, the vacuum causes the piezoelectric film 104 to be pulled against the disk 108 generally uniformly across the apertures 112. Uniformity of tension of the piezoelectric film 104 suspended over the apertures 112 is important to ensure uniformity of the resonant frequencies produced by the piezoelectric film 104 over each of the apertures 112. In effect, each of the piezoelectric film 104 and aperture 112 combinations forms a miniature emitter element or cell 124. By controlling the tension of the piezoelectric film 104 across the disk 108, the cells 124 advantageously respond generally uniformly.

A second reason for the vacuum is that it advantageously eliminates any possibility of unintentionally generating “back-wave” distortion. In other words, by definition, a compression wave requires that there be a compressible medium through which it can travel. If the piezoelectric film 104 can be caused to generate ultrasonic compression waves “outward” in the direction indicated by arrow 130 from the emitter drum transducer 100, it is only logical that ultrasonic compression waves are also being generated from the piezoelectric film 104 which will travel in an opposite direction, backwards into the emitter drum transducer 100 in the direction indicated by arrow 132. Consequently, these backwards traveling or back-wave distortion waves can interfere with the ability of the piezoelectric film 104 to generate desired frequencies. This interference occurs when the back-waves reflect off surfaces within the emitter drum transducer 100 until they again travel up through an aperture 112 and reflect off of the piezoelectric film 104, thus altering its vibrations. Therefore, by eliminating a medium for travel of compression waves within the emitter drum transducer 100, vibrations of the piezoelectric film 104 are not interfered with.

FIG. 10 also shows that there are electrical leads 120 which are electrically coupled to the piezoelectric film 104 and which carry an electrical representation of the frequencies to be transmitted from each cell 124 of the emitter drum transducer 100. These electrical leads 120 are electrically coupled to some signal source 122 as shown.

FIG. 11A is a close-up profile view of two cells 128 in FIG. 10 (comprised of the piezoelectric film 104 over two apertures 112). The piezoelectric film 104 is shown distended inward (from its original shape 104a) toward the interior of the emitter drum transducer in an exaggerated vibration for illustration purposes only. It should be apparent from a comparison with FIG. 11B that the distention inward of the piezoelectric film 104 will be followed by a distention outward and away from the interior of the emitter drum transducer. The amount of inward and outward distention of the piezoelectric film is shown exaggerated for illustration purposes only. The actual amount of distention will be discussed later.

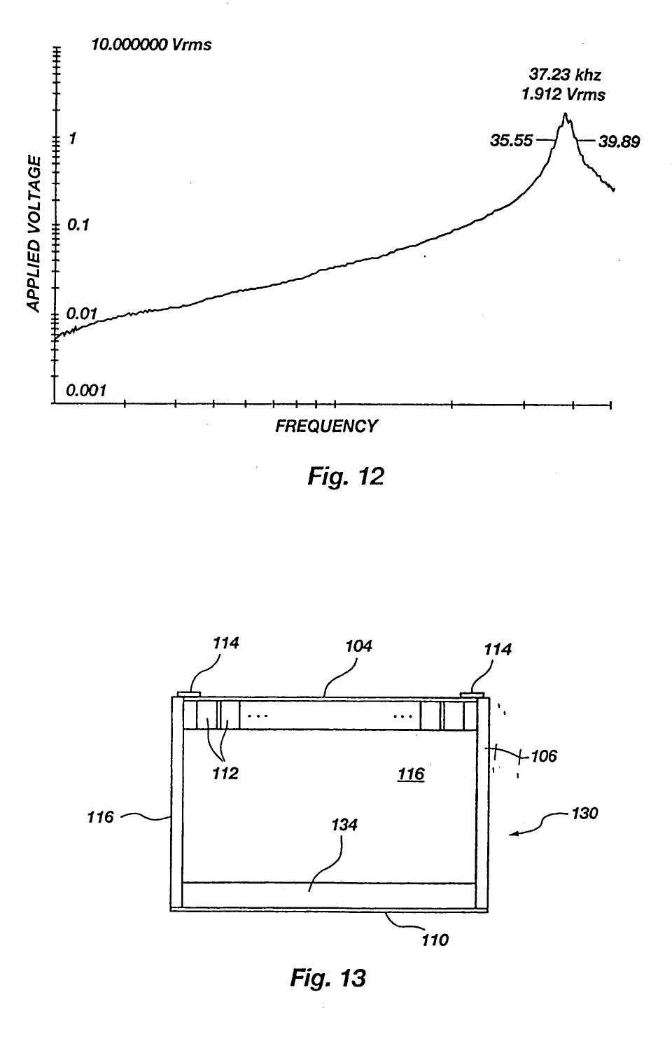

FIG. 12 is a graph showing frequency response of the emitter drum transducer produced in accordance with the principles of the preferred embodiment as compared to displacement of the piezoelectric film (as a function of applied voltage RMS). The emitter drum transducer results are exemplary of typical results at a near vacuum in the interior of the emitter drum transducer. The membrane (piezoelectric film 104) used in this embodiment is a polyvinylidiene di-fluoride (PVDF) film of approximately 28 mm in thickness. Experimentally, the resonant frequency of this particular emitter drum transducer is shown to be approximately 37.23 kHz when using a drive voltage of 73.6 Vₚₚ, with a bandwidth of approximately 11.66 percent, where the upper and lower 6 dB frequencies are 35.55 kHz and 39.89 kHz respectively. The maximum amplitude of displacement of the piezoelectric film was found to be approximately just in excess of 1 micrometer peak to peak. This displacement corresponds to a sound pressure level (SPL hereinafter) of 125.4 dB.

It is surprising that this large SPL was generated from an emitter drum transducer using a PVDF which is theoretically supposed to withstand a drive voltage of 1680 Vₚₚ, or 22.8 times more than what was applied. Consequently, the theoretical limit of these particular materials used in the emitter drum transducer result in a surprisingly large SPL of 152.6.

It is important to remember that the resonant frequency of the preferred embodiment shown herein is a function of various characteristics of the emitter drum transducer. These characteristics include, among other things, the thickness of the piezoelectric film 104 stretched across the emitter face 108 (FIG. 8), and the diameter of the apertures 112 in the emitter disk 108. For example, using a thinner piezoelectric film 104 will result in more rapid vibrations of the piezoelectric film 104 for a given applied voltage. Consequently, the resonant frequency of the emitter drum transducer 100 will be higher.

The advantage of a higher resonant frequency is that if the percentage of bandwidth remains at approximately 10 percent or increases as shown by experimental results, the desired range of frequencies can be easily generated. In other words, the range of human hearing is approximately 20 to 20,000 Hz. Therefore, if the bandwidth is wide enough to encompass at least 20,000 Hz, the entire range of human hearing can easily be generated as a new sonic wave as a result of acoustical heterodyning. Consequently, a signal with sonic intelligence modulated thereon, which interferes with an appropriate carrier wave, will result in a new sonic signal which can generate audible sounds across the entire audible spectrum of human hearing.

In addition to using a thinner piezoelectric film 104 (FIG. 10) to increase the resonant frequency, there are other ways this can be accomplished. For example, in an alternative embodiment, the present invention uses a cell 124 having a smaller diameter aperture 1112. A smaller aperture will also result in a higher resonant frequency for an applied driving voltage.

FIG. 13 shows an alternative embodiment which is at present less advantageous than the preferred embodiment of the present invention, but which also generates frequencies from an emitter drum transducer 116 which is constructed almost identically to the preferred embodiment. The essential difference is that instead of creating a vacuum within the interior of the emitter drum transducer 116, the interior is now pressurized.

The pressure introduced within the emitter drum transducer 130 can be varied to alter the resonant frequency. However, the thickness of the piezoelectric film 104 is a key factor in determining how much pressure can be applied. This can be attributed in part to piezoelectric films made from copolymers having considerable anisotropy, instead of a bidirectional film such as PVDF. The undesirable side effect of an anisotropic piezoelectric film is that it may in fact prevent vibration of the film in all directions, resulting in asymmetries which will cause unwanted distortion of the signal being generated therefrom. Consequently, PVDF is the preferred material for the piezoelectric film not only because it has a considerably higher yield strength than copolymer, but because it is considerably less anisotropic.

One drawback of a pressurized emitter drum transducer 130 is unwanted frequency resonances or spurs. These frequency spurs can be attributed to back-wave generation within the emitter drum transducer 116 because instead of a vacuum, an elastic medium is present within the emitter drum transducer 116. However, it was also determined that the back-wave could be eliminated by placing a material within the emitter drum transducer 116 to absorb the back-waves. For example, a piece of foam rubber 134 or other acoustically absorbent or dampening material can generally eliminate all frequency spurs.

Experimental results using the pressurized emitter drum transducer 130 showed that at typical selected pressures and drive voltages, the emitter drum transducer operated in a substantially linear region. For example, it was determined that an emitter drum transducer using a 28 mm thick PVDF with a pressure of 10 pounds per square inch (psi) inside the emitter drum transducer can generate a resonant frequency approximately 43 percent greater than an emitter drum transducer which has an internal pressure of 5 psi. In addition, a generally linear region of operation was discovered when it was determined that doubling the drive amplitude also generally doubles the displacement of the PVDF.

It was also experimentally determined that the pressurized emitter drum transducer could generally obtain bandwidths of approximately 20 percent. Constructing an emitter drum transducer with a resonant frequency of only 100 KHz results in a bandwidth of approximately 20 KHz. This is more than adequate to generate the entire range of human hearing. By acoustically damping the interior of the emitter drum transducer 116 to prevent introducing back-wave distortions or low frequency resonances, the pressurized embodiment is also able to achieve the impressive results of commercially viably volume levels of the preferred embodiment of the present invention.

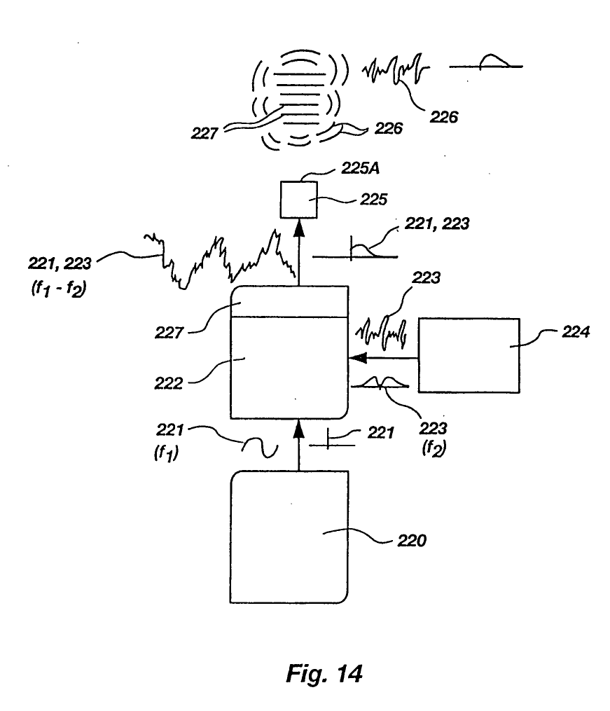

Turning to a more specific implementation of the preferred embodiment, the emitter drum transducer can be included, for example, in the system shown in FIG. 14. The system includes an oscillator or digital ultrasonic wave source 220 for providing a base or carrier wave 221. This wave 221 is generally referred to as a first ultrasonic wave or primary wave. An amplitude modulating component 222 is coupled to the output of the ultrasonic generator 220 and receives the base frequency 221 for mixing with a sonic or subsonic input signal 223. The sonic or subsonic signal may be supplied in either analog or digital form, and could be music from any conventional signal source 224 or other form of sound. If the input signal 223 includes upper and lower sidebands, a filter component 227 is included in the modulator to yield a single sideband output on the modulated carrier frequency.

The emitter drum transducer is shown as item 225, which is caused to emit the ultrasonic frequencies f₁ and f₂ as a new wave form propagated at the face of the transducer 225a. This new wave form interacts within the nonlinear medium of air to generate the difference frequency 226, as a new sonic or subsonic wave.

The present invention is able to function as described because the compression waves corresponding to f₁ and f₂ interfere in air according to the principles of acoustical heterodyning. Acoustical heterodyning is somewhat of a mechanical counterpart to the electrical heterodyning effect which takes place in a non-linear circuit. For example, amplitude modulation in an electrical circuit is a heterodyning process. The heterodyne process itself is simply the creation of two new waves. The new waves are the sum and the difference of two fundamental waves.

In acoustical heterodyning, the new waves equaling the sum and difference of the fundamental waves are observed to occur when at least two ultrasonic compression waves interact or interfere in air. The preferred transmission medium of the present invention is air because it is a highly compressible medium that responds non-linearly under different conditions. This non-linearity of air is possibly what enables the heterodyning process to take place without using an electrical circuit. Of course, any compressible fluid can function as the transmission medium if desired.

As related above, the acoustical heterodyning effect results in the creation of two new compression waves corresponding to the sum and the difference of ultrasonic waves f₁ and f₂. The sum is an inaudible ultrasonic wave which is of little interest and is therefore not shown. The difference, however, can be sonic or subsonic, and is shown as a compression wave 226 which is generated generally omni-directionally from the region of interference.

Whereas successful generation of a difference wave in the prior art appears to have had only nominal volume, the present configuration generates full sound. While a single transducer carrying the base frequency and modulated single sideband frequency was able to project sound at considerable distances and impressive volume levels, the combination of a plurality of co-linear signals significantly increases the volume. When directed at a wall or other reflective surface, the volume was so substantial that it reflected as if the wall were the very source of the sound generation.

An important feature of the present invention is that the base frequency and single sideband are propagated from the same transducer face. Therefore, the component waves are perfectly collimated. Furthermore, phase alignment is at maximum, providing the highest level of interference possible between two different ultrasonic frequencies. With maximum interference insured between these waves, one achieves the greatest energy transfer to the air molecules, which becomes the “speaker” radiating element in a parametric speaker. Accordingly, the inventors believe this may have developed the surprising increase in volume to the audio output signal.

The embodiment of FIG. 14 using an array of emitter sections on a single film diaphragm is preferred for many reasons. For example, the system does not require individual mounting of bimorph devices and will therefore be less expensive to produce. Nevertheless, the single film transducer will actually be generating a plurality of collimated signals. The system will also be lighter, smaller and, most importantly, will have the greatest efficiency. In contrast to prior art devices, the present embodiment will always generate a new compression wave which has the greatest efficiency. That is because no orientation of two separate ultrasonic transducers will ever match or exceed the perfect coaxial relationship obtained when using the same ultrasonic transducer 225 to emit the new ultrasonic wave form 227 embodying both ultrasonic compression waves. This coaxial propagation from a single aperture of the emitter drum transducer would therefore yield the maximum interference pattern and most efficient compression wave generation.

The development of full volume capacity in a parametric speaker provides significant advantage over conventional speaker systems. Most important is the fact that sound is reproduced from a relatively massless radiating element. In the region of interference, and consequently at the location of new compression wave generation, there is no direct radiating element. This feature of sound generation by acoustical heterodyning can substantially eliminate distortion effects, most of which are caused by the radiating element of a conventional speaker. For example, cone overshoot and cone undershoot can modify an otherwise pure sound reproduction signal with harmonics and standing waves on a loudspeaker cone.

This improvement will be most significant when compared with the prior art limitations of conventional speaker diaphragms. A direct physical radiating element, for example, has a frequency response which is not truly flat. Instead, it is a function of the type of frequency (bass, intermediate, or high) which it is inherently best suited for emitting. Whereas speaker shape, geometry, and composition directly affect the inherent speaker character, acoustical heterodyne wave generation utilizes the natural response of air to avoid geometry and composition issues and to achieve a truly flat frequency response for sound generation. With the achievement of acceptable amplitude levels in sound, the parametric system may now be commercially implemented in direct competition with conventional speakers—a result heretofore unrealized by prior art parametric or beat mixing devices.

Distortion free sound implies that the present invention maintains phase coherency relative to the originally recorded sound. Conventional speaker systems do not have this capacity because the frequency spectrum is broken apart by a cross-over network for propagation by the most suitable speaker element (woofer, midrange or tweeter). By eliminating the radiating element, the present invention makes obsolete the conventional cross-over network frequency and phase controls. This enables realization of a virtual or near point-source of sound.

Other advantages arise directly from the unique nature of the ultrasonic film transducers. Because of their small size and low mass, such transducers are generally not subject to the many limitations and drawbacks of conventional radiating elements used in loudspeakers. Furthermore, the use of ultrasonic transducers at extremely high frequencies avoids the distortion, harmonics and other undesirable features of a direct radiating element which must reproduce sound directly in the low, mid and high frequency ranges. Consequently, the many favorable acoustic properties of a relatively distortion free ultrasonic transducer system can now be transferred indirectly into sonic and subsonic by-products.

FIGS. 15 and 16 disclose a further embodiment of the piezo film diaphragm and support plate which does not require application of pressure or use of a drum. The illustrated transducer 160 includes a base plate 161 and a supported film diaphragm 162 made of piezo material. Electrical contacts on the film enable application of a voltage as previously discussed. The arcuate emitter sections 165 are molded or thermo-formed to a stable configuration. Corresponding cavities or openings in a top face of the support plate 161 are aligned to receive the curved portion of the film. These cavities have sufficient depth to allow the emitter sections to move freely, without incurring interfering contact with the cavity wall 167. The intermediate surfaces 168 of the support plate contact the flat portion 162a of the film and stabilize the film and emitter sections for proper alignment as illustrated with collimated propagation axes 170. In-phase operation occurs because the film is a monolithic structure which responds uniformly to the applied voltage to generate compression waves 172 which are in phase and properly aligned.

The support plate 161 may be constructed from any rigid material which provides the ability to stabilize the emitter film 162 for correct operation. Conductive plates may be used in place of the contacts 163, to enable application of the signal voltage to the piezo film. The illustrated piezo film comprises a copolymer film having unidirectional response oriented transverse the elongate emitter sections, as illustrated by line 174. This is in contrast to bidirection films such as PVDF. The unidirectional film has approximately 80% of its shape distension along the transverse direction 174, and therefore provides excellent response. With the larger size of arcuate emitters 165, increased surface area provides favorable SPL output.

FIG. 17 illustrates one method for implementing the present invention with an alternative method for forming the emitter sections 180. This relies on displacement of a monolithic, flat sheet of piezo material into arcuate shapes by a support plate 183 having bumps 184 configured with the desired emitter shape. A force F is applied to deform the film over the bumps as shown. This force may be tension applied from the periphery of the film to draw the film against the bumps, or other suitable methods. The bumps are desirably made of foam material to enable the vibration of the piezo film in response to the applied voltage.

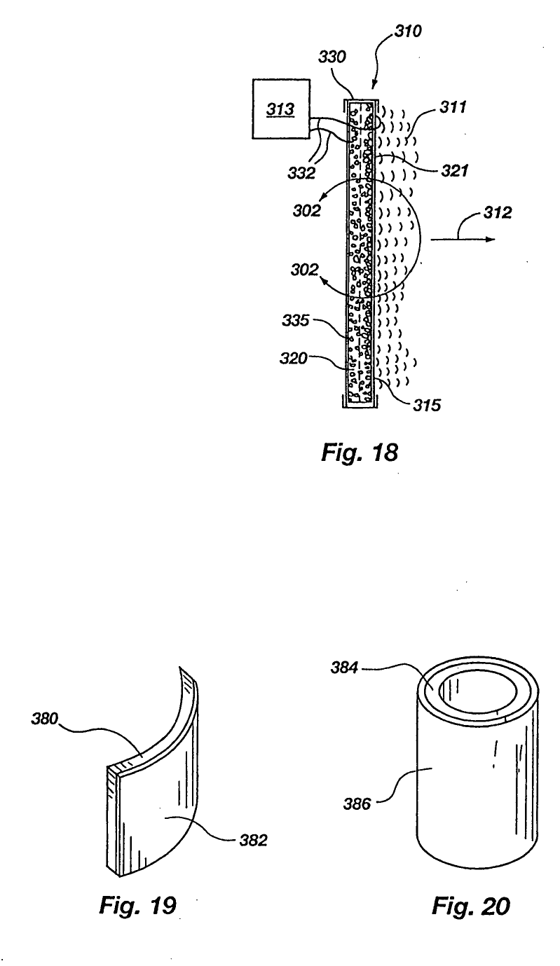

An additional alternative embodiment of the present invention uses foam stators with an electrostatic diaphragm to produce ultrasonic parametric compression waves. FIG. 18 shows a single-end speaker device 310 with ultrasonic output 311 being propagated in a forward direction 312. This speaker may be coupled to an ultrasonic driver 313 which provides the various electronic circuitry support elements for applying the desired signal as previously discussed.

This output 311 can be ultrasonic output, and this output can create a parametric loudspeaker. A parametric loudspeaker in air results from intense, audio modulated ultrasonic signals into an air column. Self demodulation, or down-conversion, occurs along the air column resulting in an audible acoustic signal. This process occurs because of the known physical principle that when two sound waves with different frequencies are radiated simultaneously in the same medium, a sound wave having a wave form including the sum and difference of the two frequencies is produced by the non-linear interaction (parametric interaction) of the two sound waves. So, if the two original sound waves are ultrasonic waves and the difference between them is selected to be an audio frequency, an audible sound is generated by the parametric interaction. The foam stator construction of the present invention can be used for ultrasonic output because the emitter diaphragm or film can create useful ultrasonic sound wave(s).

The device includes an electrostatic emitter film 315 which is responsive to an applied variable voltage to emit ultrasonic output. The emitter film comprises a plastic sheet and thin metallic coating or other conductive surface. Electrostatic emitter films will be generally referred to hereafter as electrostatic devices. Typically, the plastic sheet is a Mylar™, Kapton™ or other nonconductive composition which can serve as an insulator between the metal layer and a stator member 320. A surface or coating having partial conductivity may be used to develop charge distribution uniformly across the diaphragm surface. A preferred range of resistivity is greater than 10K ohms. This provides less charge migration and prevents static buildup leading to arcing A higher impedance such as 100 M ohms is not uncommon in this application. Obviously, this selection also affects the capacitance between two plates.

One of the primary features of this embodiment of invention involves the use of a foam member as the stator 320. The stator serves as a base member or rigid component which offers inertia with respect to the light, flexible emitter film 315. This stator is a conductive element which supplies one polarity to the capacitor combination. Resistivity of this component is selected to favor a uniform charge migration to avoid arcing and other adverse effects inherent in electrostatic systems. A preferred composition which has demonstrated effective properties is conventional static packing foam (generally known as “conductive foam”) used as packing material with computers and other charge sensitive contents. This material operates to provide static discharge away from sensitive components. It not only protects the components from adverse electrical discharge or exposure, but is very light weight and inexpensive. It is typically formed in a conventional foam molding device in virtually any shape, density, or dimension.

Prior art use of the material has generally been limited to a passive role (packing material) whose purpose is merely to protect sensitive components. Like other packing material, utility was based on temporary placement for filling space within a carton or container. Often, this material is discarded with the container as having no independent value. Its presence within the electronics market has been taken for granted and is evidenced by massive quantities in landfills throughout the world.

The drawings illustrate a foam composition with random pockets or cavities. Use of available technology also permits more uniform sizing of voids within the plastic matrix. Therefore, the stator component may be tuned or optimized for specific frequency applications, resonances, and related properties. Stiffness or rigidity of the foam will be a function of material properties, as well as pocket density and wall thickness defining the respective voids or pockets. Accordingly, further control of stator acoustic response can be controlled by variations in numerous physical parameters, in addition to control of random versus uniform void sizing. The importance of rigidity within the stator element is well known, and can now be partially affected by new design factors associated with the uniqueness of a foam composition.

Although the foam member illustrated comprises an open cell structure, a combination of open and closed cell structure is also available. The advantage of open cell structure is bidirectional propagation of sound. This bidirectional aspect has been dampened in the FIG. 18 embodiment by attachment of a nonporous membrane 335 on the rear face of the foam member. This membrane may also be replaced by a stiffening member formed of plastic or some other rigid material. The stiffening member may be attached to conform to a desired speaker configuration.

For example, conventional electrostatic speakers are usually planar because the diaphragm is not in contact with the stator, but is suspended in front of the stator. It is therefore difficult to bend the diaphragm in a curved path without distorting the gap between the stator and film. With the present invention having direct contact of the emitter film on the face of the foam, however, a curved configuration is as simple to form as a planar shape. Indeed, the curved surface offers a desirable resistance against the film which performs part of the biasing function for enhancing contact. The ability to mold virtually any form or shape with foam permits equal latitude in configuring various shapes for the speaker face. For example, the speaker may be a curved surface as shown in FIG. 19, providing improved dispersion of sound propagation. The stator 380 of FIG. 19 is curved and film 382 conforms to that curve. The configuration can be circumferential as with a cylinder in FIG. 20 and a sphere (not shown). The stator 384 of FIG. 20 is a cylinder and the film 386 also forms a cylinder. Each of these embodiments offers unique dispersion patterns which have been very difficult to incorporate within electrostatic speaker systems, particularly for audio output.

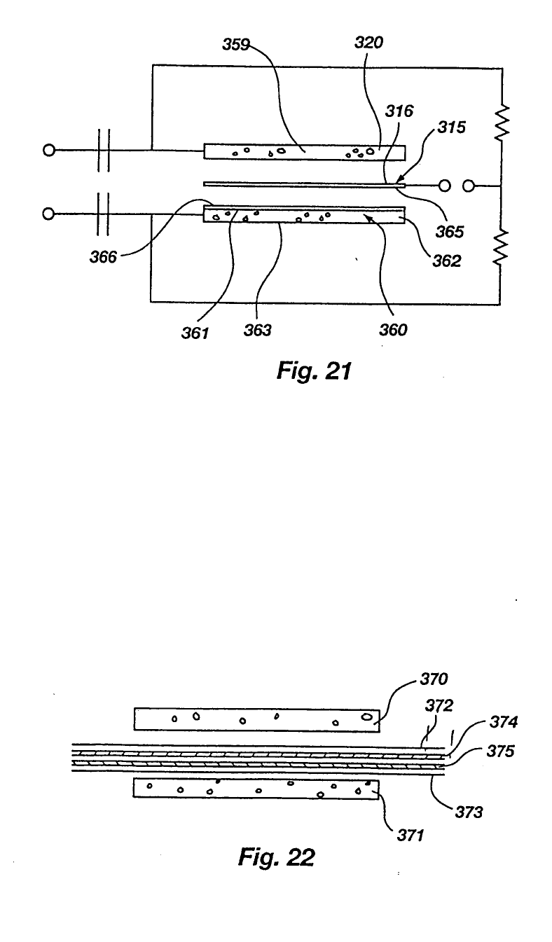

An additional embodiment of this invention provides push-pull operation and is illustrated in FIG. 21. It includes a first foam member 359, second foam member 360 having a forward face 361, an intermediate core section 362 and a rear face 363. The forward face of the second foam member (referred to as the second forward face) is positioned on an opposing side of the electrostatic emitter film 365 from the first foam member. The second forward face is composed of a composition having sufficient stiffness to support the electrostatic film and includes conductive properties which enable application of the variable voltage to the second forward face to supply the desired ultrasonic signal. The second forward face 361 comprises a surface including small cavities as discussed above, with surrounding wall structure defining each cavity, said surrounding wall structure terminating at contacting edges approximately coincident with the forward face of the foam member. Film application means (not shown) for applying the electrostatic film to the forward face of the second foam member would follow the format as with the single-end embodiment above. As above, biasing means 366 are coupled to the second foam member for biasing the film in direct contact with the contacting edges of the second forward face 361 such that the film is directly supported by the second forward face. The signal source is also applied to the second forward face with the variable voltage.

The electrostatic emitter film 365 needs to include a conductive layer in non-contacting relationship with the respective first and second foam members for enabling the film to capacitively respond with the first and second forward faces to the variable voltage in a push-pull relationship. An insulating member may be required with respect to the second foam member.

Several configurations of the emitter film are possible. For example, FIG. 22 shows first and second foam members 370 and 371 which sandwich the film member. In this case, the electrostatic emitter film comprises at least two sheets 372 and 373 of nonconductive emitter film which respectively included a conductive surface 374 and 375. The nonconductive emitter film provides insulation between the conductive layer and the respective first and second forward faces. The respective conductive surfaces 374 and 375 are bonded together to form an integral conductive layer.

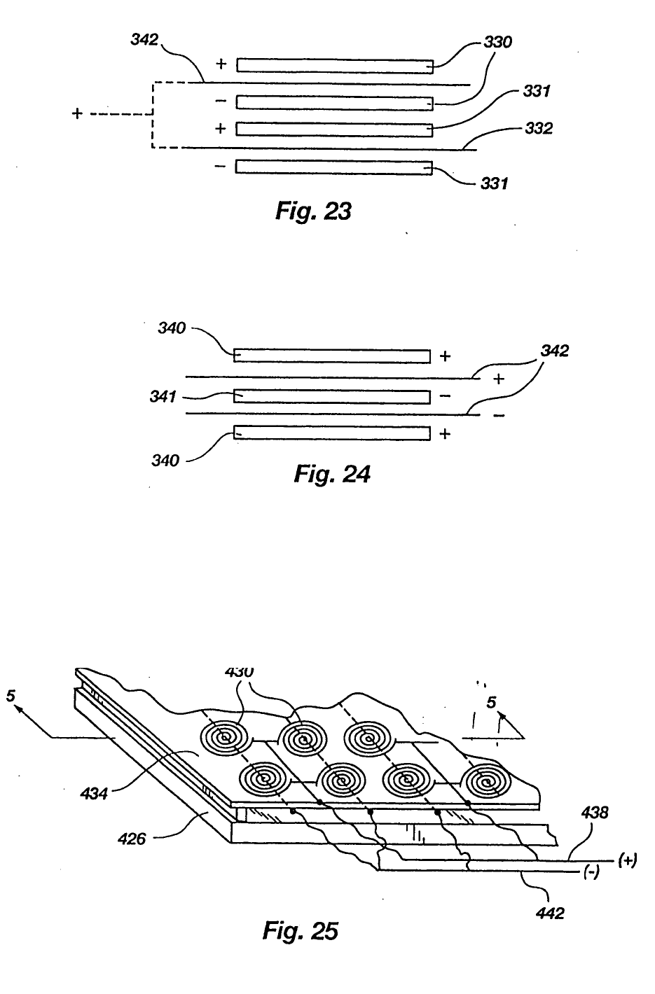

FIGS. 23 and 24 illustrate the use of multiple emitter films 332 and 342, sandwiched between foam or general support members 330, 331, 340, 341. Each additional emitter film will add approximately 3 db output to the emitted ultrasonic signal. It will be apparent that numerous configurations can be adapted within this multiple combination pattern.

Yet another embodiment of the present invention involves planar magnetic film diaphragms which use magnetic forces to create a parametric transducer. FIG. 25 depicts one configuration of the present invention. Specifically, it comprises an ultrasonic emitter having broad frequency range capacity with relatively large diaphragm displacement compared to the nominal movement of a typical electrostatic diaphragm. Indeed, orthogonal displacement (peak to peak movement of the diaphragm from a full extended to a full retracted position) may be as great as 1-2 mm. This compares very favorably with a movement range of 0.1 to 3 micrometers for a rigid transducer emitter face.

The benefits of extended motion for the magnetic diaphragm of the present invention include a significant increase in amplitude in ultrasonic and sonic output for a parametric array. The enhanced sonic output of the present invention is enabled by use of a magnetic field generated by a magnetic core member 426. This core may be a permanent magnet or a composition adapted for electromagnetic use. Such materials may be either flexible or rigid, depending upon the configuration of the speaker array. For example, a planar plate will generate a column of sound which has surprising projection capacity over long distances. A curved emitter diaphragm may be formed and supported by a curved support core made of flexible magnet material similar to removable magnets attached to appliances, etc. This curved configuration provides a greater dispersion pattern for projected sound, and also enables a sense of directional movement to emitted sound. This can be implemented by sequentially triggering sound transmission along a linear sequence of emitter elements (or conductive coils) 430 disposed along the diaphragm 434. When these elements are radiated outward in a diverging configuration, the audience perceives the source as having a physical element of motion along that direction.

Returning to the basic embodiment of FIG. 25, it will be noted that a permanent, rigid magnetic core or plate 426 has been used as a support for the flexible emitter diaphragm 434. This permanent magnet 426 operates as the primary means for establishing a first magnetic field adjacent the core member, in a manner similar to the permanent magnet of an acoustic speaker. In this case, however, there is no telescopic core or recess which receives the stator element. Instead, the core 426 is a planar body which establishes a uniform magnetic field along its length, thereby providing necessary counter force for a variable magnetic field to be established in the diaphragm 434.

The illustrated movable diaphragm 434 is stretched along the core member 426 and displaced a short separation distance from the core member to allow an intended range of orthogonal displacement of the diaphragm with respect to the core member and within a strong portion of the magnetic field. Typically, this diaphragm 434 comprises a thin film of Mylar or other strong, lightweight polymer. Many such materials are already in use in the electrostatic speaker or ultrasonic emitter industry.

The enhanced displacement of the diaphragm 434 is enabled by at least one, low mass, planar, conductive coil (or emitter element 430) disposed on the movable diaphragm. The thin conductive coil 430 creates a magnetic field when current is conducted through the coil. The present inventor has discovered that the power of a magnetic field can be implemented in a voice coil disposed on planar film, yielding the benefits of substantial diaphragm 434 displacement far beyond prior art electrostatic speaker systems. This current is supplied to the coil 430 by first and second contacts 438 and 442 which are coupled to a power source. The first contact 438 is coupled to one end of the coil 430, typically at a side common with the coil itself. The second contact 442 is disposed on the opposing side of the coil 430, thereby providing electrical isolation from the first contact 438. The illustrated embodiment shows the second contact 442 penetrating the film (or diaphragm 434) and extending along the opposite face of the film to a pick up point for closing the circuit for current flow. Other methods of electrically isolating the respective first and second contacts will be apparent to those skilled in the art.

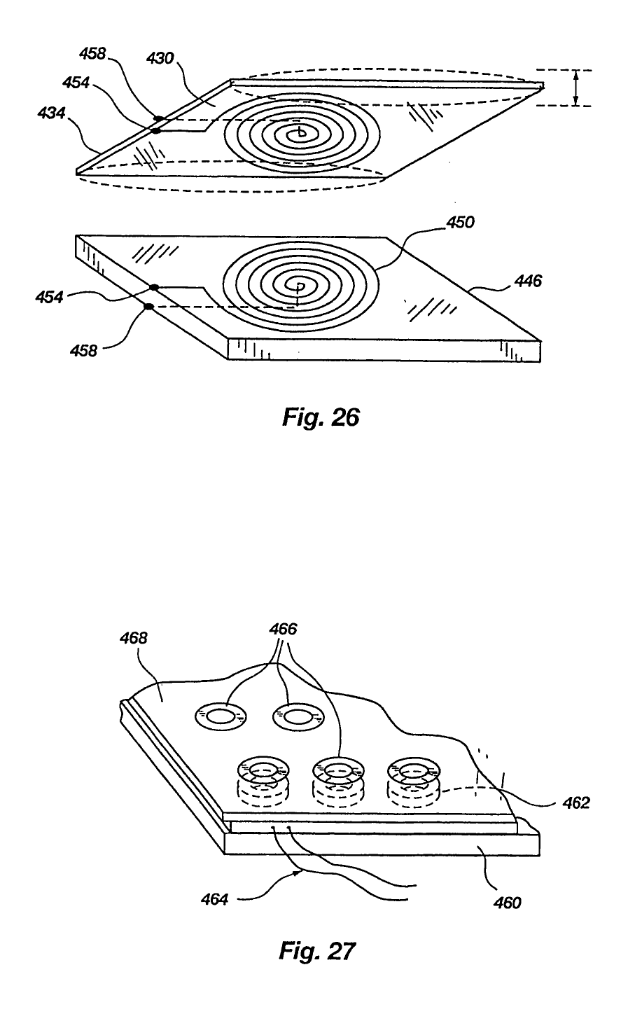

As shown in FIG. 26, a further alternate embodiment of the core member could comprise a rigid plate 446 formed of nonmagnetic composition, one surface of which includes at least one opposing conductive coil 450 similar in design to the conductive coil 430 described for the diaphragm. Such a coil would include first and second contacts 454 and 458 for enabling current flow through the opposing conductive coil 450 to thereby establish the required second magnetic field. This at least one opposing conductive coil 450 would be positioned on the rigid plate in a location which is juxtaposed to the at least one conductive coil 430 on the vibrating or movable diaphragm 434 to enable the at least one conductive coil 430 and the at least one opposing conductive coil 450 to cause respective magnetic fields from each coil to interact to develop the compression waves emitted from the diaphragm.

Again, the first contact 454 is positioned on one side of the diaphragm and the second contact 458 is positioned on an opposing side of the diaphragm. This may be in the form of a single coil as illustrated in FIG. 26, or as a plurality of conductive coils equally spaced along the diaphragm as depicted in FIG. 25. Ideally, the conductive coils 430 and 450 are disposed in a plurality of rows in juxtaposed position to maximize uniformity of the magnetic field, as well as the quantity of coil applied.

FIG. 27 depicts an alternative planar magnetic configuration of a parametric speaker. Specifically, it comprises a core member 460 for giving rigid support, at least one conductive coil 462 coupled to the core, and a diaphragm 468 which includes a conductive ring 466 which responds to a magnetic field developed by the conductive coil. The operative principles in this structure are founded on the nature of a conductive ring to develop current flow when passed through a magnetic field. Specifically, when a conductive ring experiences a magnetic field gradient, a current will flow through the ring in an orientation which establishes a magnetic moment counter to the magnetic force generated by the coil. This phenomenon results in a repulsion between the coil and the conductive ring. Many physics students have observed the power of this repulsive force in classroom demonstrations which launch an aluminum ring twenty to thirty feet into the air. The interaction between the coil 462 and the ring 466 is partially described by two principles of physics commonly known as Faraday's Law of Induction and Lenz's Law. See Fundamentals of Physics, Halliday and Resnick, Second Edition, Chapter 34.

The present inventors have applied these principles to generate a speaker diaphragm which variably extends and retracts to create a desired series of compression waves. By applying an array of conductive rings to a resilient, flexible film such as Mylar™ or Kapton™, etc., and superimposing this film over a corresponding array of conductive coils, it is possible to repel the film to a biased state of tension and, via modulation of the amplitude of current through the coils, to develop a controlled diaphragm oscillation. The resilience of the film allows its retraction to the biased rest position in which the film is in a slightly stressed, extended state. This biased, rest position is developed by a base or carrier signal of alternating current which maintains a minimum level of repulsion between the coils and rings.

A continuous input of variable alternating current which is modulated with intelligence enables translation of frequency and amplitude representing the intelligence into physical compression waves representing sound. Thus, a conventional modulated carrier such as a sinusoidal wave can be used to supply a desired audio output signal to the described magnetic film emitter to develop an effective speaker system.

This system also provides a unique capacity for use as an ultrasonic emitter having broad frequency range capacity with relatively large diaphragm displacement compared to the nominal movement of a typical electrostatic diaphragm. The magnetically repelled film of the present embodiment, however, provides an orthogonal displacement (peak to peak movement of the diaphragm from a fully extended to a biased rest position) which may be as great as several millimeters. Therefore, the diaphragm displacement of the present invention compares very favorably with a substantially smaller movement range of a rigid transducer emitter face, or even the flexible diaphragm of a conventional electrostatic emitter.

Such enhanced displacement is possible because the effective range of a magnetic field extends greater distances than the short range forces associated with an electrostatic field. It will therefore be noted that whereas the effective force of the electrostatic emitter may extend only in the range of micrometers, the magnetic diaphragm of the present invention has a greater range by a factor of more than one hundred. Therefore, the use of magnetic force is able to repel or attract an emitter diaphragm over a significantly greater path.

The benefits of extended motion for the large magnetic diaphragm of the present invention include a significant increase in amplitude of sonic output for a parametric or acoustic heterodyne array, as compared to a comparable system of bimorph transducers. Furthermore, near linear response is stronger with the film emitter, compared to the rigid transducers. These are significant factors that enable the field of parametric speakers to have enhanced commercial utility, whereas such utility has been somewhat limited to date.

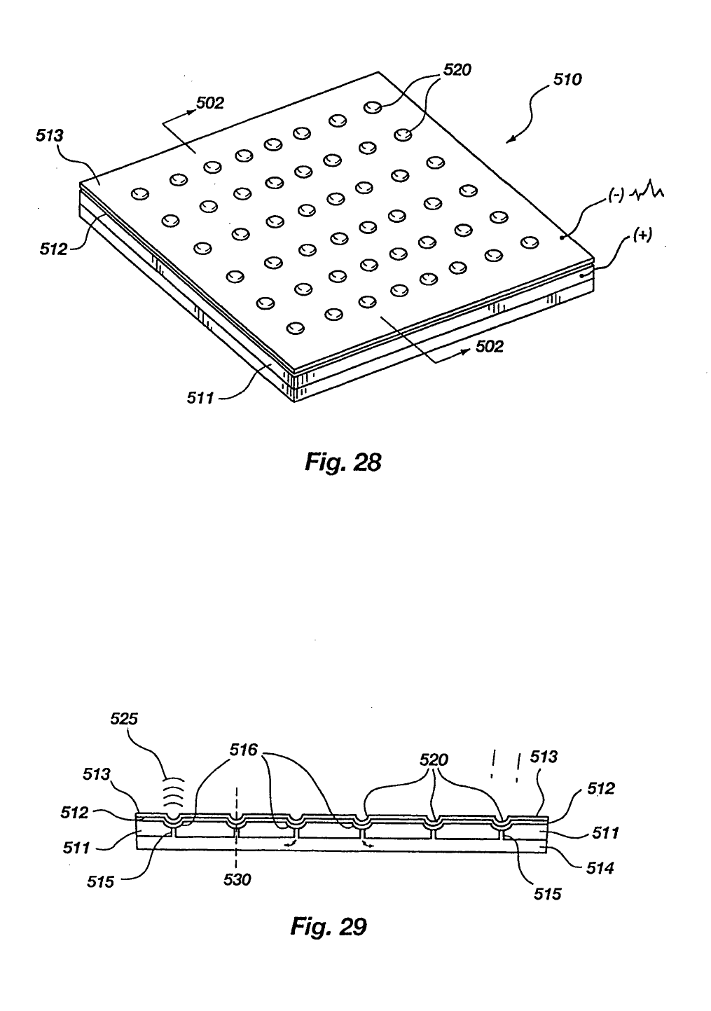

Another embodiment of this invention is illustrated in FIG. 28 showing an electrostatic emitter 510. Specifically, the emitter comprises a rigid substrate 511 capable of carrying a voltage, a thin film dielectric material 512 suspended over the substrate, and a conductive layer 513 positioned over the dielectric film 512. Typically, the dielectric material 512 (such as Mylar) is coated with a conductive film 513 directly on its top surface. Therefore, the basic emitter 510 is operable with just the substrate and the metallic coated Mylar film.

As shown in FIG. 29, the preferred embodiment also includes an air chamber 514 disposed below the substrate, with small passageways 515 for air flow between the chamber and small cavities 516 formed at a top surface of the substrate.

Referring to both FIG. 28 and FIG. 29, the rigid substrate 511 may be formed of materials which have been applied in electrostatic emitters generally in the prior art. These include molded plastics, wood, silicon wafers coated on a top side with a conductive surface, or simply conductive materials processed with a top side to include the required cavities. A cross-sectional view of this structure is provided in FIG. 29. The rigid substrate 511 is shown with small conduits 515 communicating from the air chamber 514 to each cavity 516 formed in the top surface of the substrate. This chamber 514 operates as a common pressure chamber, providing a more uniform tension across the dielectric film 512 because of the common pressure associated with the chamber and each connected cavity 516. This chamber 514 can also be subjected to a negative pressure to mechanically bias the thin film 512 into the recessed cup shape 520 as shown in FIG. 28. Use of biasing pressure avoids well known problems associated with the use of a biasing voltage.

It is this recessed cup 520 which becomes the vibrating emitter element which responds to a variable signal input enabling propagation of the ultrasonic carrier signal with side bands which heterodyne to generate a column of audio sound 525. The present invention provides a uniform recessed cup referred to as an emitter element, which is substantially isolated from the effects of adjacent emitter elements to develop a carefully tuned, resonant frequency of uniform value. The cavities 516 formed in the substrate 511 are preferably precision molded in uniform size and configuration. This permits a more precise uniformity among the respective cavities 516 to yield a more finely tuned resonant frequency.

The embodiment of the present invention just described provides surprising results as a parametric speaker device. It provides an array of cavities which respectively and indirectly generate audio output within an emitted ultrasound column. The occurrence of ultrasonic heterodyning within each of these columns emitted from tuned emitter elements actually reinforces the sound pressure level (SPL) at a distance from the emitters. As shown in FIG. 29, each emitter section 520 propagates a column of sound 525 which is highly directional. By providing an array of many emitting sectors 520 uniformly tuned to a desired resonant frequency, a simulation of a uniform wave front is accomplished with much greater amplitude than from an electrostatic diaphragm comprising a single film operable on a single voltage source. The use of uniform cavities is also an advantage over the prior art in manufacturing which is duplicatable and therefore predictable. Prior art techniques required quality control that includes careful inspection of every emitter substrate to insure that an operable surface of pits or cavities was developed. This was necessary because mechanical and chemical etching techniques produce varying results depending on differences in the environment, the materials used, and the random nature of the process. In contrast, the present embodiment can be practiced with conventional molding or machining procedures.

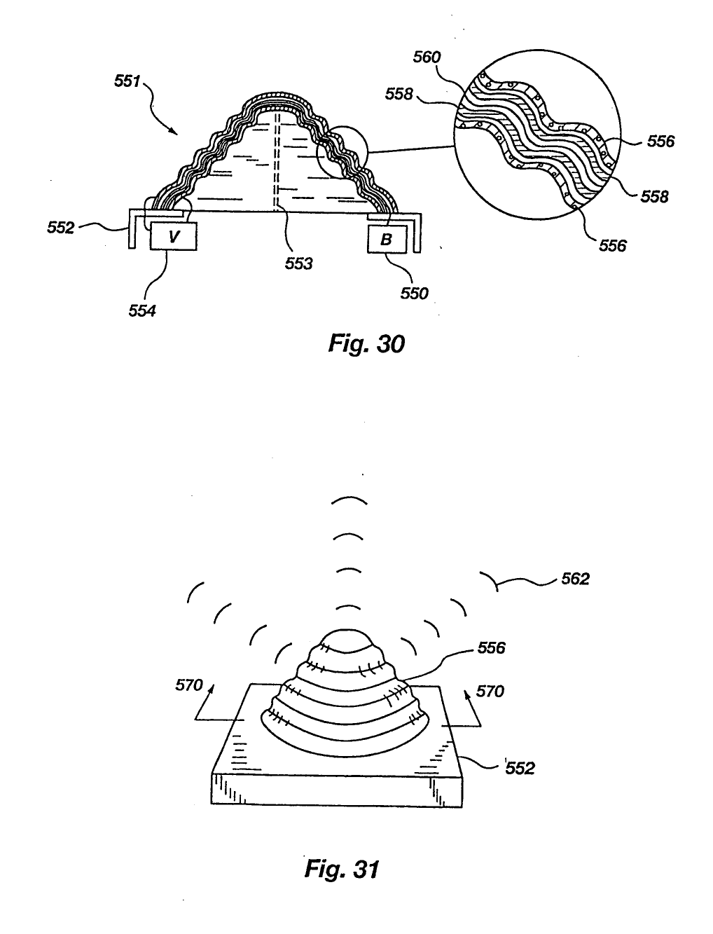

Another embodiment of an ultrasonic electrostatic transducer is shown in FIG. 30. A cross section view of a hemispherical electrostatic transducer 551 is shown anchored to a base 552. FIG. 30 is a cross section of FIG. 31 along arrow 570. Two cylindrical corrugated stators 556 create a hemispherical shape and a non-planar diaphragm 560 is arranged between the two opposing stators. In addition, a supporting structure 553 runs along the inside of the hemisphere or along a longitudinal axis of the hemisphere. It should be realized that the stators have holes or apertures, so they are acoustically transparent and allow ultrasonic waves to pass through. The diaphragm is biased by a bias voltage 550 and the audio signal 554 is applied to produce an ultrasonic compression wave. A cushioning or insulating layer 558 is contained within the stators so the diaphragm will not directly contact the conductive layer on the stators and avoids other distorting contact with the stator.

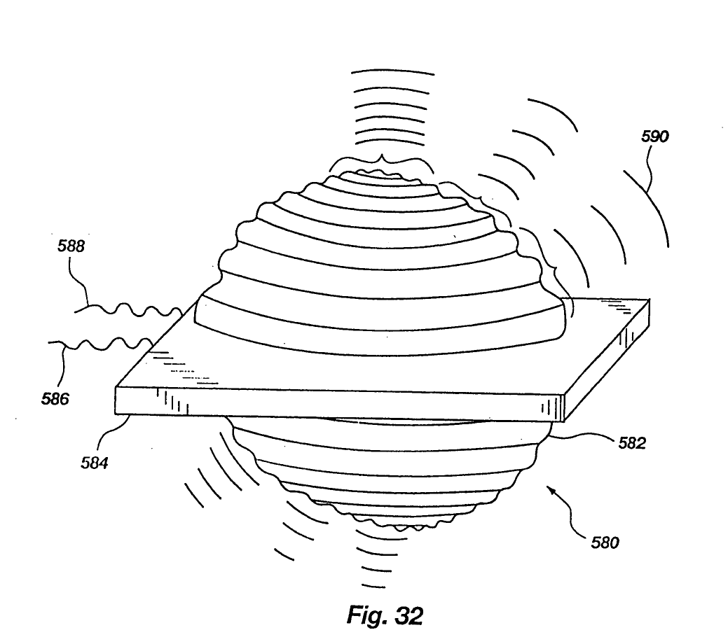

FIG. 31 is a perspective view of a hemispherical electrostatic speaker. Because of the hemispherical nature of this embodiment, the sound that emanates through the stators 556 radiates in 180 degrees in multiple axes. A full sphere embodiment of the present embodiment is shown in FIG. 32. This figure shows a perspective view of the spherical embodiment 580 which is a combination of two hemispheres as shown in FIG. 31. This spherical arrangement allows the ultrasonic sound waves 590 to be generated in all possible directions. A base 584 which may contain an electrical assembly connects the two hemispheres. An electrical assembly can also be sized small enough to be contained within the hemispheres and a much smaller base 584 could be used. Of course other base shapes such as a circle could be implemented. A bias is applied to the diaphragms contained within the hemispheres through the input 588 and the audio signal is then applied through 586.

It will be apparent that numerous variations and combinations may be developed by those skilled in the art, based upon the aforementioned embodiments of the present invention. Accordingly, it is to be understood that the invention is to be defined in accordance with the following claims, and not limited by specific examples set forth above.

1. A method for generating parametric audio output based on interaction of multiple ultrasonic outputs within air as a nonlinear medium, said method comprising the steps of:
a) generating an electronic signal comprising at least two ultrasonic signals having a difference in value which falls within an audio frequency range;
b) transferring the electronic signal to an electrostatic emitter diaphragm which couples directly with the air as part of a single stage energy conversion process;
c) converting the electronic signal at the diaphragm directly to mechanical displacement as a driver member of a parametric speaker; and
d) mechanically emitting the at least two ultrasonic signals from the diaphragm into the air as ultrasonic compression waves which interact within the air to generate the parametric audio output.

2. A method as defined in claim 1, wherein step b) comprises the more specific step of transferring the electronic signal to an electrostatic transducer.

3. A method as defined in claim 1, wherein step b) comprises the more specific step of transferring the electronic signal to an electret transducer.

4. A method as defined in claim 1, wherein step b) comprises the more specific step of transferring the electronic signal to an electro mechanical film diaphragm as the electrostatic emitter diaphragm.

5. A method as defined in claim 1, wherein step b) comprises the more specific step of transferring the electronic signal to a plastic film diaphragm as the electrostatic emitter diaphragm.
